(19) United States
(12) Patent Application Publication
(10) Pub. No.: US 2012/0047845 A1
(43) Pub. Date: Mar. 1, 2012

(54) Masonry block core fill nozzel

(76) Inventor: Jon A. Lest, Littleton, CO (US)

(21) Appl. No.: 12/806,999

(22) Filed: Aug. 26, 2010

(51) Int. Cl. E04G 21/04; B05B 1/00

(52) U.S. Cl. 52/742.14; 239/589

(57) ABSTRACT

A masonry block core fill nozzle for filling cores in a hollow block wall with a masonry grout mix is provided. The masonry block core fill nozzle has a hollow manifold body. The body has side walls, an upper wall, a bottom wall, a first end and a second end. The side walls terminate, adjacent to the first end, in a downwardly projecting u-shaped edge formation. The bottom wall is truncated in relation to the first end so that a ventral nozzle opening is formed between the first end and the lower wall. The body has a conduit with an inlet and an outlet ends. The ends are in fluid communication with the ventral nozzle opening. The outlet end is connected to the second end of the manifold body, and the inlet end has a fitting which is adapted for coupling to a grout hose.

### CROSS REFERENCE TO RELATED APPLICATIONS

None.

### BACKGROUND OF THE INVENTION

1. Field of the Invention

The present invention relates to masonry grout fill pumping. In particular, it relates to a masonry block core fill nozzle and system for filling the cores of top course of a hollow block wall with a masonry block fill mix.

2. Description of the Related Art

Concrete reinforced blocks are a very common building materials for use in the construction of the load-bearing walls of buildings. These blocks are typically formed with hollow cores, or cells, in order to reduce weight, improve insulation, and to allow for the use of additional rebar, concrete, or mortar mix which runs vertically through the hollow block cores so as to improve the tensile strength of the wall. This use of hollow blocks allows building structures to be constructed in the traditional masonry fashion with courses of overlapping blocks. In the United States the most common size for such blocks is 20cm×20cm×41 cm.

With most applications, the applicable building codes require that the cores, in the top course of the hollow block wall, shall be filled with a masonry block fill mix. Over time, these requirements have been more frequently subject to strict enforcement by building inspectors. Because the top course, of a hollow block wall, is constructed vertically to fit up against the horizontal structural members; which comprise the basic structural framework of a building, conventional block fill mortar pump nozzles, normally used in conjunction with conventional masonry block fill pumping systems, such as a hook hose nozzles, do not fit in the narrow crevice which results when the top course is completed below the horizontal structural members which comprise the structural framework of the building under construction. Heretofore, in order to meet this requirement, the mortar is pressed into to block cores, of the top course, by masons using traditional masonry tools, such as a trowel. In this manner, the traditional methods require the mason to undertake the steps of mixing the mortar to a proper slump, loading the mortar onto a hawk, and pressing the mortar, with a hand-held trowel, into the narrow gap created between the upper margin of the blocks defining the top course, and the lower portion of the upper structural members which are in place above the top course. As one might imagine, this method of delivering mortar into the cores, or cells, of the top course of a block wall is a very tedious and time consuming process, and is performed without the ability to take advantage of the use of masonry grout pumping nozzles and block fill pump systems which provide for batch mixing of the block fill mix and pumping of the mix into the block cores through a grout hose.

While use of the foregoing traditional tools and methods to fill the cores of the blocks, which make up the top course of a hollow block wall, offers some utility, it desirable to eliminate the need for the manual filling of the top course cores with tradition masonry tools. It is also desirable to provide a masonry block fill nozzle for use as a component of a grout pumping system in order to reduce the number of man hours required in the filling of the cores in the top course of a hollow block wall. The present invention satisfies these needs.

### BRIEF SUMMARY OF THE INVENTION

It is therefore an object of the present invention to eliminate the need for filling the cores in top course of a hollow structural block wall with traditional hand held tools.

It is yet another object of the present invention to provide a masonry block core fill nozzle for use with a block fill pumping system in order to fill the cores of the hollow blocks which make up the top course of a hollow block wall.

To overcome the problems of the prior art and in accordance with the purpose of the invention, as embodied and broadly described herein, briefly a masonry block core fill nozzle for filling cores in a hollow block wall with a masonry grout mix is provided. The masonry block core fill nozzle has a hollow manifold body. The body has side walls, an upper wall, a bottom wall, a first end and a second end. The side walls terminate, adjacent to the first end, in a downwardly projecting u-shaped edge formation. The bottom wall is truncated in relation to the first end so that a ventral nozzle opening is formed between the first end and the lower wall. The body has a conduit with an inlet and an outlet ends. The ends are in fluid communication with the ventral nozzle opening. The outlet end is connected to the second end of the manifold body, and the inlet end has a fitting which is adapted for coupling to a grout hose.

Additional advantages of the present invention will be set forth in part in the description that follows and in part will be obvious from that description or can be learned from practice of the invention. The advantages of the invention can be realized and obtained by the invention particularly pointed out in the appended claims.

### BRIEF DESCRIPTION OF THE SEVERAL VIEWS OF THE DRAWINGS

The accompanying drawings, which are incorporated in and which constitute a part of the specification illustrate at least one embodiment of the invention and, together with the description, explain the principles of the invention.

FIG. 1 illustrates an operator using the present invention to fill the cores of the hollow block wall top course with a masonry block fill mix.

FIG. 2 is an isometric view of the preferred embodiment of the masonry block core fill nozzle, in accordance with the present invention, showing the handle used in order to position and control the masonry block core fill nozzle between the upper periphery of the top course and a lower margin of a horizontal structural member.

FIG. 3 is an isometric right-side view of the preferred embodiment of the masonry block core fill nozzle showing the ventral nozzle opening when positioned in vertical alignment with a core to be filled, and below the overhanging horizontal structural member.

FIG. 4 is a sectional side view of the preferred embodiment of the masonry block core fill nozzle in accordance with the present invention.

FIG. 5 is a sectional view showing the first end of the masonry block core fill nozzle in relation to the truncated bottom wall so as to form the ventral nozzle opening.

FIG. 6 is a bottom view of the masonry block core fill nozzle in accordance with the present invention.

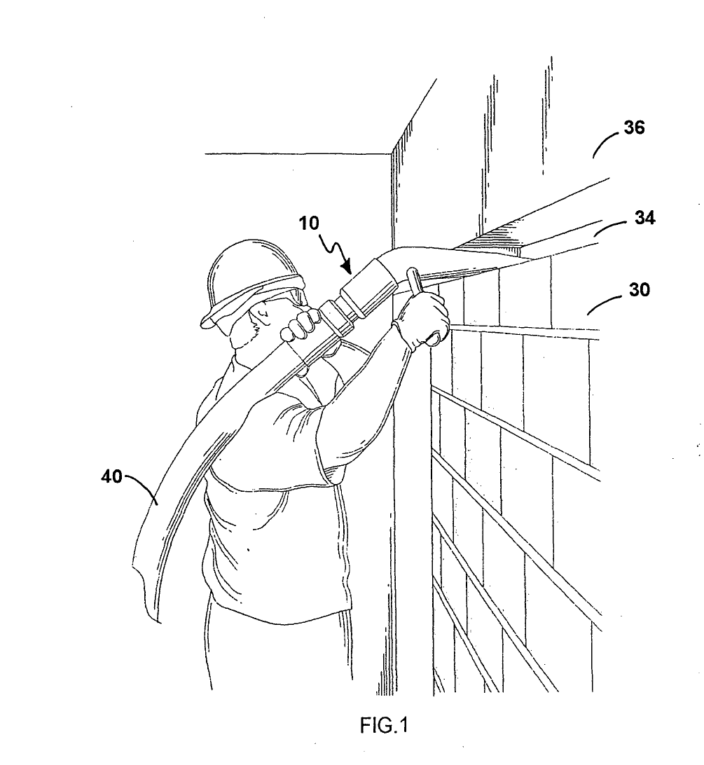

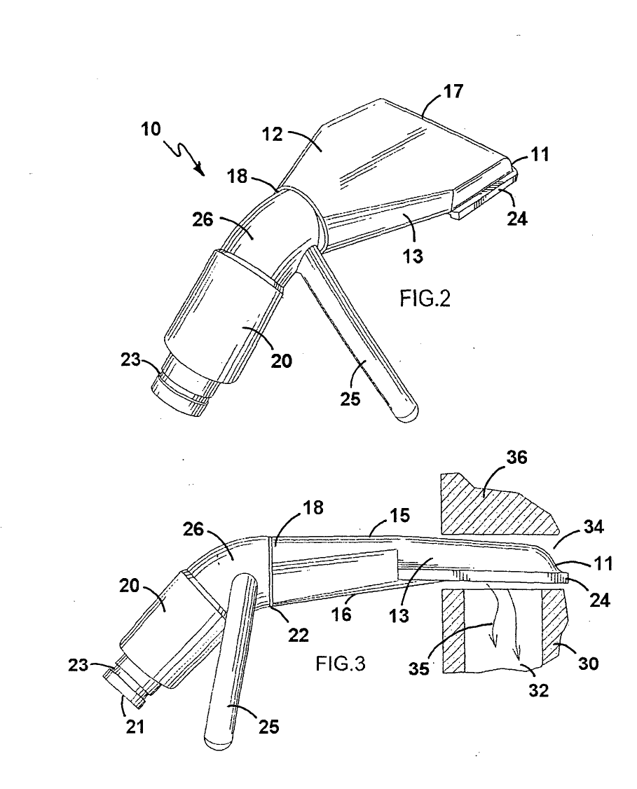

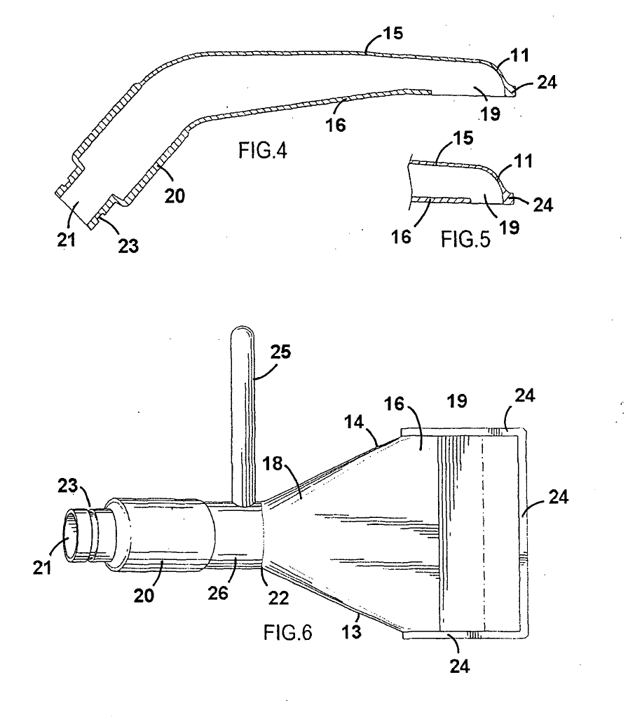

### DETAILED DESCRIPTION OF THE INVENTION

Unless specifically defined otherwise, all technical or scientific terms used herein have the same meaning as commonly understood by one of ordinary skill in the art to which this invention belongs.

Although any of the methods and materials which are similar or equivalent to those described herein can be used in the practice or testing of the present invention, the preferred methods and materials are now described. Reference will now be made in detail to the presently preferred embodiments of the invention, examples of which are illustrated in the accompanying drawings wherein like numerals represent like features of the invention.

Referring now to the drawing figures, the preferred embodiment of the present invention provides a masonry block core fill nozzle 10 for filling cores 32, in the top course 30 of a hollow block wall, with a masonry grout mix in the direction illustrated as arrows 35. The masonry block core fill nozzle 10 has a hollow manifold body 12. The body 12 has side walls 11, 13, 14, an upper wall 15, a bottom wall 16, a first end 17 and a second end 18. In the same manner as the side walls 13, 14, the upper wall 15 also terminates, adjacent to the first end 17, in a downwardly projecting side wall 11 so that the sidewalls 11, 13, 14 form a generally u-shaped edge surrounding the outer periphery of the ventral nozzle opening 19. The bottom wall 16 is truncated, in relation to the first end 17 side wall 11, so that the ventral nozzle opening 19 is formed between the side walls 11, 13, 14 and the bottom wall 16. The nozzle opening 19 is desirably dimensioned as a generally rectangular opening which may, but need not, be sized slightly larger than the rectangular opening of the cores to be filled.

The block core fill nozzle 10 uses a conduit 20 with an inlet 21 and an outlet ends 22 for fluid communication with the grout hose 40 and the nozzle opening 19. The conduit 20 is desirably a pipe having a diameter in the range of 2.54 cm to 7.62 cm. The conduit 20 ends 21, 22 are in fluid communication with the ventral nozzle opening 19. The outlet end 22 adjoins the second end 18 of the manifold body 12, and the inlet end 21 has a fitting 23 which is adapted for coupling the inlet 21 to a grout hose 40. The fitting 23 is desirably formed as a channel, or groove, in the conduit 20, so that it is adapted for connecting to the grout hose 40 quick coupling or for use with a snap clamp. In a preferred embodiment, the block core fill nozzle 10 conduit 20 further uses an elbow formation 26 which is positioned adjacent to the outlet end 22 of the conduit 20 portion of the block core fill nozzle 10. With this embodiment, the elbow formation 26 is connected so that an angular relationship is created between the inlet 21 and a generally horizontal plan such that the ventral nozzle opening 19 may easily be carried along the horizontal plan for insertion of the block core fill nozzle 10 in to the narrow gap, or crevice 34, located between the upper surface of the top course 30 and horizontal structural member 36. Preferably, the elbow formation 26 is cylindrical in shape and adjoins the manifold body 12 where the body 12 becomes an irregular concave polygon formation tapering outwardly from the elbow formation 26 to a point which is proximal to the ventral nozzle opening 19.

In the preferred embodiment, a handle 25 may, but need not, be connected to the conduit 20 preferably at, and extending lateral to, the elbow formation 26. The handle 25 extends laterally and, even more preferably, is angled downwardly in relation to the sidewalls 13, 14 of the manifold body 12. With this embodiment, the operator may easily use the handle 25 as a lever arm for insertion of the ventral nozzle opening 19, of the manifold body 12, in the crevice 34, which is created between the upper surface of the top course 30 and the upper horizontal structural member 36, in order to maintain a downward pressure of the ventral nozzle opening 19 in a position which is substantially flush with the upper margin of the core 32 to be filled. In order to further strengthen the ventral nozzle opening 19 against damage during use, the manifold body 12 may also, but need not, include a u-shaped flange 24 which extends outwardly from the lateral and terminal edges of the side walls 13, 14 and first end 17 edge formations and around the exterior portion of the ventral nozzle opening 19. The u-shaped flange 11 is thereby easily biased against the upper periphery of the top course 30 when filling the cores 32 with the masonry block fill mix in the direction which is represented by the arrows 35.

In use, with conventional block fill pumping equipment; the foregoing masonry block core fill nozzle 10 is an indispensible component of a novel system for filling the cores 32 of a masonry block wall with a masonry block fill mix in the direction represented by the arrows 35. Here, the system includes a block fill pump (not shown), a grout hose 40, and a grout hose coupling, all of which are well known to a person of skill in the art. Such grout fill pumps are typically designed to include a batch mixing vessel for mixing the masonry block fill mix, and are powered by either gas or electric motors. A grout hose 40, typically having a diameter in the range of 2.54 cm to 7.62 cm, is coupled to the grout pump and the block core fill nozzle 10, with a grout hose coupling, such as a quick coupling or snap clamp. The operator then easily locates the manifold body 12 portion of the block core fill nozzle 10 between the top course 30, of the hollow block wall, and the horizontal structural member 36 so that the ventral nozzle opening 19 is in vertical alignment with the core 32 to be filled, and pumps the masonry block fill mix, in the direction 35, through the manifold body 12 and into the hollow block core 32 until the cores 32 of the top course 30 are filled with the masonry block fill mix.

While the present invention has been described in connection with the embodiments as described and illustrated above, it will be appreciated and understood by one of ordinary skill in the art that certain modifications may be made without departing from the true spirit and scope of the invention, as described and claimed herein.

I claim:

1. A masonry block core fill nozzle for filling cores in a hollow block wall with a masonry grout mix, comprising:
(a) a hollow manifold body including side walls, an upper wall, a bottom wall, a first end and a second end, wherein the side walls terminate adjacent to the first end in a downwardly projecting u-shaped edge formation, and the lower wall is truncated in relation to the first end so that a ventral nozzle opening is formed between the first end and the bottom wall for delivering the grout fill mix into the core of the hollow block wall, and
(b) a conduit having an inlet and an outlet ends in fluid communication with the ventral nozzle opening, the outlet end connected to the second end of the manifold body and the inlet end having a fitting adapted for coupling to a grout hose.

2. The masonry block core fill nozzle according to claim 1, wherein the fitting is adapted for connecting a quick coupling.

3. The masonry block core fill nozzle according to claim 1, wherein the fitting is adapted for connecting a snap clamp.

4. The masonry block core fill nozzle according to claim 1, further comprising a handle connected to the conduit.

5. The masonry block core fill nozzle according to claim 1, wherein the second end of the manifold body includes an elbow formation.

6. The masonry block core fill nozzle according to claim 1, wherein the manifold body further comprises a flange extending outwardly from at least three sides of the ventral nozzle opening.

7. The masonry block core fill nozzle according to claim 5, wherein the elbow formation is substantially cylindrical and the manifold body is a substantially irregular concave polygon formation tapering outwardly from the elbow formation to a point which is adjacent to the ventral nozzle opening.

8. A method for masonry block fill pumping of a masonry block fill mix in the top course of a hollow block wall, comprising the steps of:
(a) providing a block fill pump, a grout hose, and a grout hose coupling;
(b) providing a masonry block fill mix in fluid communication with the block fill pump;
(c) providing a masonry block core fill nozzle including a hollow manifold body including side walls, an upper wall, a bottom wall, a first end and a second end, wherein the side walls terminate adjacent to the first end in a downwardly projecting u-shaped edge formation, and the lower wall is truncated in relation to the first end so that a ventral nozzle opening is formed between the first end and the bottom wall for delivering the grout fill mix into the core of the hollow block wall, and a conduit having an inlet and an outlet ends in fluid communication with the ventral nozzle opening, the outlet end connected to the second end of the manifold body and the inlet end having a fitting adapted for coupling to a grout hose;
(d) connecting the block core fill nozzle conduit to the grout hose using the grout hose coupling, and connecting the grout hose to the block fill pump;
(e) locating the manifold body between the top course of the hollow block wall and a horizontal structural member so that the ventral nozzle opening in vertical alignment with the core to be filled; and
(f) pumping the masonry block fill mix through the manifold body into the hollow block core.

9. The masonry block core fill nozzle according to claim 8, wherein the fitting is adapted for connecting a quick coupling.

10. The masonry block core fill nozzle according to claim 8, wherein the fitting is adapted for connecting a snap clamp.

11. The masonry block core fill nozzle according to claim 8, further comprising a handle connected to the conduit.

12. The masonry block core fill nozzle according to claim 8, wherein the second end of the manifold body includes an elbow formation.

13. The masonry block core fill nozzle according to claim 8, wherein the manifold body further comprises a flange extending outwardly from at least three sides of the ventral nozzle opening.

14. The mortar block core fill nozzle according to claim 12, wherein the elbow formation is substantially cylindrical and the manifold body is a substantially irregular concave polygon formation tapering outwardly from the elbow formation to a point which is adjacent to the ventral nozzle opening.

15. A system for masonry block fill pumping of a masonry block fill mix in the top course of a hollow block wall, comprising:
(a) a block fill pump, a grout hose, and a grout hose coupling; and
(b) a masonry block core fill nozzle including a hollow manifold body including side walls, an upper wall, a bottom wall, a first end and a second end, wherein the side walls terminate adjacent to the first end in a downwardly projecting u-shaped edge formation, and the lower wall is truncated in relation to the first end so that a ventral nozzle opening is formed between the first end and the bottom wall for delivering the grout fill mix into the core of the hollow block wall, and a conduit having an inlet and an outlet ends in fluid communication with the ventral nozzle opening, the outlet end connected to the second end of the manifold body and the inlet end having a fitting coupling to a grout hose.

16. The masonry block core fill nozzle according to claim 15, wherein the fitting is adapted for connecting a quick coupling.

17. The masonry block core fill nozzle according to claim 15, wherein the fitting is adapted for connecting a snap clamp.

18. The masonry block core fill nozzle according to claim 15, further comprising a handle connected to the conduit.

19. The masonry block core fill nozzle according to claim 15, wherein the second end of the manifold body includes an elbow formation.

20. The mortar block core fill nozzle according to claim 17, wherein the elbow formation is substantially cylindrical and the manifold body is a substantially irregular concave polygon formation tapering outwardly from the elbow formation to a point which is adjacent to the ventral nozzle opening.
